(19) United States
(12) Patent Application Publication
(10) Pub. No.: US 2023/0316428 A1
(43) Pub. Date: Oct. 5, 2023

(54) SYSTEM AND METHOD FOR TAILORING USER EXPERIENCES

(71) Applicant: Advent, LLC, Nashville, TN (US)

(72) Inventors: John David Downie, Nashville, TN (US); Todd Larrell Austin, Brentwood, TN (US)

(21) Appl. No.: 18/128,150

(22) Filed: Mar. 29, 2023

Related U.S. Application Data
(60) Provisional application No. 63/325,016, filed on Mar. 29, 2022.

(51) Int. Cl. G06Q 50/00

(52) U.S. Cl. CPC G06Q 50/01

(57) ABSTRACT

The present technology relates to developing tailored user experiences based on interests and environmental data stored in an experience management system. A method of the disclosed technology can include determining a mobile device associated with a user has entered an environment associated with a personalized experience tour, receiving spatial information from the mobile device, wherein the spatial information includes contextual information of a portion of the environment that the user is in, determining, based on an identity of the user, subjects that the user is interested in, generating, based on the subjects that the user is interested in, one or more waypoints, wherein the one or more waypoints are objects in the environment that the user may be interested in, guiding the user to the one or more waypoints, and providing personalized content for a respective object through the mobile device to the user at the one or more waypoints.

### BACKGROUND

### 1. Technical Field

The subject technology pertains to developing tailored user experiences, and more particularly to developing tailored user experiences based on user interests and environmental data of objects related to the interests.

### 2. Introduction

People often travel and visit various sites that they have never been to. When visiting these new areas, people can easily get lost. For example, mixed-use districts can be confusing due to the division of various different areas, such as a medical facility, retail spaces, restaurants, etc. As another example, in sporting events, people can generally get lost in the crowd and may miss many interesting areas that may be of interest to them, such as halls showcasing achievements of a team that the person likes. As yet another example, college candidates typically visit college campuses and can easily get lost, especially when campuses are large. To exacerbate these issues, some visitors visit these areas unannounced, which can complicate facilitating a smooth tour of the areas. Although some facilities attempt to remedy this by providing simple signs, these can fall short in providing personalized user experiences. In other words, there is a need in the art for improving the user experience of users visiting a given area or environment.

### BRIEF DESCRIPTION OF THE DRAWINGS

FIG. 1 illustrates an environment having one or more objects and a mobile device according to an example of the instant disclosure.

FIG. 2 illustrates a block diagram of an environment having a mobile device and a remote computing system according to an example of the instant disclosure.

FIG. 3 is a flowchart of a method for developing tailored user experiences according to an example of the instant disclosure.

FIG. 4 is a flowchart of a method for training a machine learning model to tailor a user experience for a user visiting an environment according to an example of the instant disclosure.

FIG. 5 is a flowchart of a method for generating content associated with tailored user experiences according to an example of the instant disclosure.

FIG. 6 shows an example of a system for implementing certain aspects of the present technology.

### DETAILED DESCRIPTION

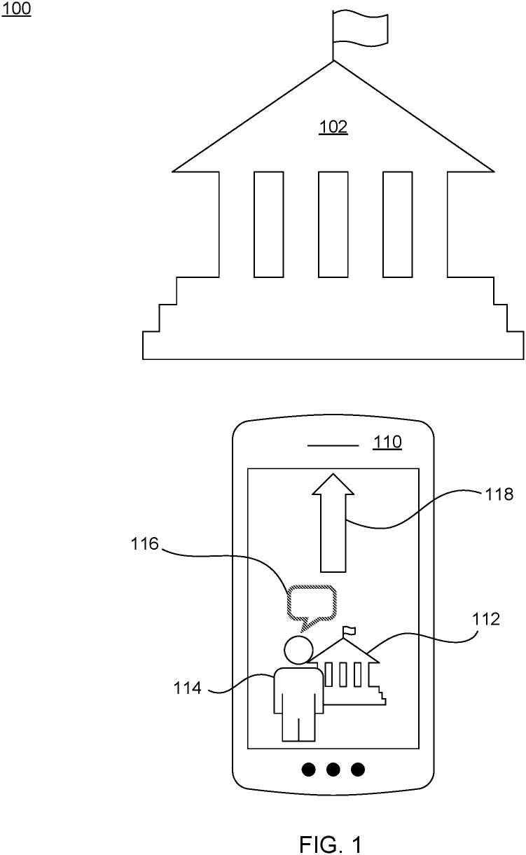

FIG. 1 illustrates an environment 100 having an object 102 and a mobile device 110. Environment 100 can be a variety of different types of environments or areas. For example, environment 100 can be a medical facility, a college campus, a mixed-use district, etc. Object 102 can be a point of interest or object in environment 100. For example, object 102 can be a statue of an athlete on a college campus. As another example, object 102 can be a building or stadium on a college campus.

Mobile device 110 can be a cellular phone, tablet, or any other mobile device. Mobile device 110 can be associated with a user using mobile device 110. Mobile device 110 can be configured to capture or obtain information about environment 100 via sensors on mobile device 110 (e.g., a camera of mobile device 110). Additionally, mobile device 110 can present a virtual representation 112 of object 102 captured by sensors of mobile device 110. Furthermore, mobile device 110 can generate or overlay various different elements over or present alongside virtual representation 112. For example, mobile device 110 can present, generate, and/or overlay a holographic avatar 114 of a person alongside virtual representation 112. As another example, mobile device 110 can present and/or overlay contextual information or additional details 116 about object 102. As yet another example, mobile device 110 can provide guidance 118 for the user to follow to get to various objects 102 in environment 100.

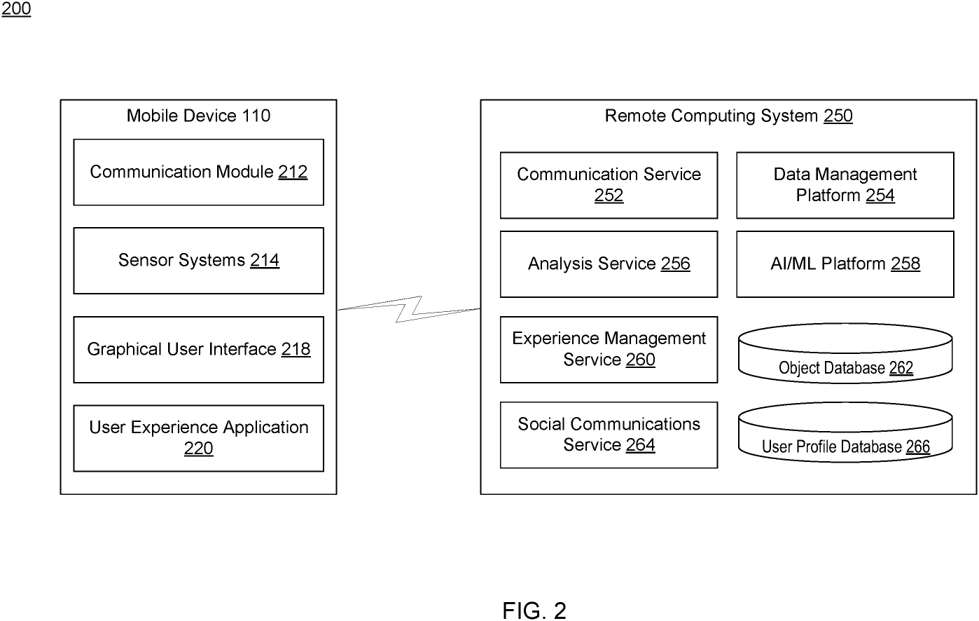

FIG. 2 illustrates a block diagram of an environment 200 having a mobile device 110 and a remote computing system 250. Mobile device 110 can be configured to have a communication module 212, sensor systems 214, a graphical user interface (GUI) 218, and a user experience application 220.

Communication module 212 can transmit and receive signals between the various other modules, systems, interfaces, and applications of mobile device 110 and between mobile device 110 and remote computing system 250 and/or other mobile devices 110. Communication module 212 can enable mobile device 110 to exchange information remotely over a network, such as a mobile or cellular network (e.g., Third Generation (3G), Fourth Generation (4G), Long-Term Evolution (LTE), Fifth Generation (5G), etc.), other wireless network connections, and/or local wireless connections (e.g., Wireless Local Area Network (WLAN), Bluetooth®, infrared, etc.).

Sensor systems 214 can include various different types of sensors including, but not limited to, cameras (e.g., still image cameras, video cameras, etc.), e.g., (infrared sensors), global positioning systems (GPS) receivers, audio sensors (e.g., microphones), accelerometers, etc. Sensor systems 214 can be used to obtain sensor data regarding information around mobile device 110.

GUI 218 can allow users to interact with mobile device 110 through visual indicator representations presented on a display of mobile device 110. For example, GUI 218 can provide an area for a user to input categories of interest. As another example, GUI 218 can display and/or present guidance 118 to objects 102.

User experience application 220 is configured to provide the user with a tailored or personalized user experience when visiting environment 100. User experience application 220 can be configured to utilize sensor systems 214 to receive and record sensor data to determine a location of mobile device 110. For example, a GPS signal can be used to determine a location of mobile device 110. In some embodiments, the usage of user experience application 220 may be in an indoor facility where a GPS signal may be inaccurate and/or imprecise. Thus, user experience application can also utilize other sensor systems 214 to determine the location of mobile device 110. For example, one or more cameras of mobile device 110 can capture at least a portion of environment 100 (e.g., at least a portion of an object 102) and determine, based on the at least a portion of environment 100, the location of mobile device 110. In some embodiments, mobile device 110 can send the captured portion of environment 100 to remote computing system 250, which can determine the location of mobile device 110.

Additionally, user experience application 220 can request and receive information from remote computing system 250 to provide the user with the tailored or personalized user experience. For example, user experience application 220 can, via communication module 212, request and receive information regarding objects 102 within environment 100 that are associated with a specific sport, such as football.

Remote computing system 250 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. Remote computing system 250 can include one or more computing devices remote to mobile device 110 for tailoring user experiences through user experience application 220.

Remote computing system 250 can be configured to have a communication service 252, a data management platform 254, an analysis service 256, an artificial intelligence (AI)/machine learning (ML) platform 258, an experience management service 260, an object database 262, a social communications service 264, and a user profile database 266.

Communication service 252 can transmit and receive signals between various other services, platforms, and databases of remote computing system 250 and between remote computing system 250 and mobile devices 110. Communication service 252 can send and receive various signals to and from mobile device 110. These signals can include sensor data captured by sensor systems 214, user experience application 220 requests and responses, user identity (e.g., a user profile or user credentials), etc. For example, communication service 252 can send and receive audio snippets captured by a mobile device.

Data management platform 254 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., mobile devices 110, enterprise systems, social networks, etc.), data having different rates of change (e.g., batch, streaming, etc.), or data having other heterogeneous characteristics. The various platforms and systems of remote computing system 250 can access data stored by the data management platform 254 to provide their respective services.

Analysis service 256 is configured to receive data from mobile device 110 and analyze the data. For example, analysis service 256 can be configured to analyze correlations between or among interests of users, objects in an environment, feedback from users regarding their interest in the objects in the environment, etc. As another example, analysis service 256 can analyze various data including, but not limited to, audio snippets obtained by sensors of mobile device 110, camera or image data obtained by sensors of mobile device 110, etc.

AI/ML platform 258 can provide the infrastructure for training and evaluating machine learning algorithms for generating personalized user experiences for a given environment. Using AI/ML platform 258, data scientists can prepare data sets from data management platform 254; select, design, and train machine learning models; evaluate, refine, and deploy the models; maintain, monitor, and retrain the models; and so on. For example, AI/ML can provide the infrastructure for training and evaluating machine learning algorithms based on the data received from mobile device 110.

Experience management service 260 is configured to generate or tailor personalized user experiences for users in a given environment. More specifically, experience management service 260 can be configured to fetch objects from an object database 262 based on interests of a user (e.g., computed interests or interests determined by experience management service 260). Experience management service 260 can then be configured to generate the personalized user experience, which can include additional information about objects, guidance to objects in the form of waypoints, holographic avatars of people who may not be currently present in the environment, etc.

Object database 262 can store various objects and related data of the objects. For example, in an embodiment where the environment is a college campus, object database 262 can store a football stadium as an object and associate the object with associated information including, but not limited to, the name of the stadium, year the stadium was built, historical or significant matches played at the stadium, etc.

Social communications service 264 can be configured to connect users with other users. More specifically, social communications service 264 can act as a proxy for communication between a user of a first mobile device and a user of a second mobile device.

User profile database 266 can store user profiles associated with mobile devices. Additionally, user profile database 266 can be used to facilitate social communications (e.g., via social communications service 264) by permitting communications between specific user profiles.

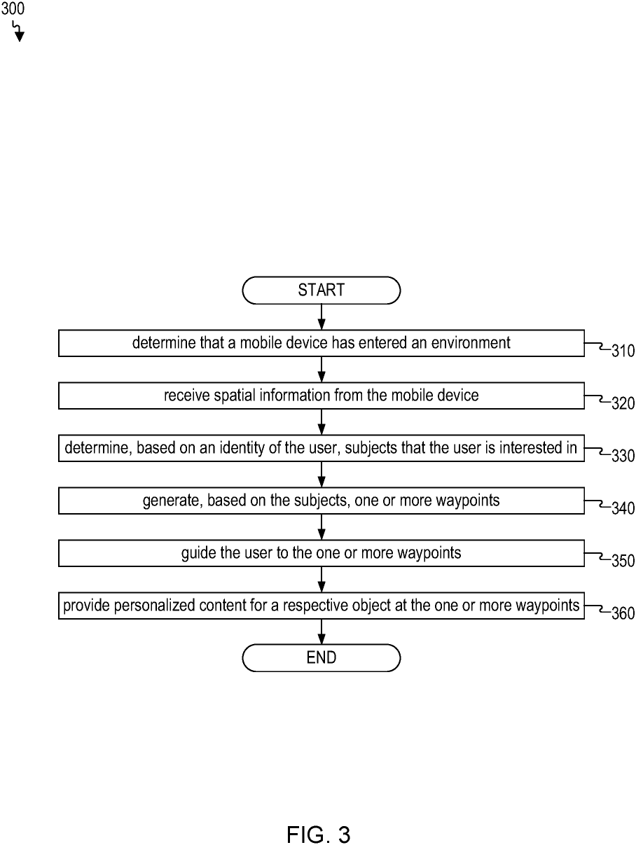

FIG. 3 illustrates an example method 300 for developing tailored user experiences based on user interests and environmental data stored and/or generated in an experience management system. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some embodiments, method 300 includes determining that a mobile device associated with a user has entered an environment associated with a personalized experience tour at step 310. For example, experience management system 260 illustrated in FIG. 2 may determine that a mobile device associated with a user has entered an environment associated with a personalized experience tour. In some embodiments, the code is configured to send the notification to the experience management system. In some embodiments, determining that the mobile device has entered the environment includes receiving a notification that the mobile device has scanned a code or trigger in the environment.

According to some embodiments, method 300 includes receiving spatial information from the mobile device at step 320. For example, experience management system 260 illustrated in FIG. 2 may receive spatial information from the mobile device. In some embodiments, the sensor data can be positional data from a GPS sensor and/or image data from a camera of the mobile device. In some embodiments, the spatial information includes contextual information of a portion of the environment that the user is in. In some embodiments, the spatial information is obtained as sensor data from sensors of the mobile device. For example, the user may direct mobile device 110 to a graphic element 102 (e.g., a wall graphic or mural, signage, totem, statute, etc.) within a physical space 100, such that sensors 214 of mobile device 110 can capture the scene 100 as data that user experience application 220 can utilize to determine the location and/or orientation of mobile device 110. In some embodiments, user experience application 220 can produce a unique signature of the viewed or captured scene 100 and compare the captured scene 100 with a list of pre-existing scenes 262 within experience management system 260. If the existing signature matches, then experience management system 260 can stream media associated with the capture scene 100 and/or objects 102 within environment 100 back to mobile device 110. In some embodiments, user experience application 220 can detect the location of mobile device 110 based on analysis of sign and comparison to signs in experience management system 260.

According to some embodiments, method 300 includes determining, based on an identity of the user, subjects that the user is interested in at step 330. For example, experience management system 260 illustrated in FIG. 2 may determine, based on an identity of the user, subjects that the user is interested in. In some embodiments, determining the subjects that the user is interested in includes at least one of receiving a list of interests from the mobile device that the user generates, analyzing biometric data of the user in response to an object in the portion of the environment, and using a machine learning to determine potential interests of the user. In some embodiments, a directory of available endpoints or objects of interest can be pulled from experience management system 260 or object database 262 based on a determined location of the mobile device 110. Users can then select required objects of interest or destinations as waypoints.

According to some embodiments, method 300 includes generating, based on the subjects that the user is interested in, one or more waypoints at step 340. For example, experience management system 260 illustrated in FIG. 2 may generate, based on the subjects that the user is interested in, one or more waypoints. In some embodiments, the one or more waypoints are objects in the environment that the user may be interested in. In some embodiments, generating the one or more waypoints includes searching a database stored on the experience management system. In some embodiments, experience management system 260 can calculate a route including the one or more waypoints and send the route information to mobile device 110.

According to some embodiments, method 300 includes guiding the user to the one or more waypoints at step 350. For example, experience management system 260 illustrated in FIG. 2 may guide the user to the one or more waypoints. For example, a potential recruit for a sports center can be at a sports center. The recruit can walk around the physical space and stop at various points along a predetermined experience journey path, which is defined within experience management system 260. In some embodiments, the user is directed to locate indoor signage of a particular type to begin wayfinding. In some embodiments, wayfinding or guidance data can be presented on mobile device 110 and primary navigation can augment other images displayed on mobile device 110. It is further contemplated that experience management system 260 can constantly compute wayfinding probabilities based on various other factors (e.g., mobile device inertial sensor array, elapsed time between known trigger point activations, positioning sensor data, Wi-Fi triangulation, Simultaneous Localization and Mapping (SLAM) camera sense input, etc.). For example, location of mobile devices 110 or users can be determined by triangulating a location for a specific user. More specifically, by using the location of a first user and a second user, the location of a third user can be triangulated based on various factors (e.g., audio analysis, visual scene comparison, wireless connections, etc.). It is also contemplated that at any point in a journey, the user can point mobile device 110 at any physical object, wayfinding signage, or other experience management system 260 defined totem to update directions and receive new augmented directions.

According to some embodiments, method 300 includes providing personalized content for a respective object through the mobile device to the user at the one or more waypoints at step 360. For example, experience management system 260 illustrated in FIG. 2 may provide personalized content for a respective object through the mobile device to the user at the one or more waypoints. In some embodiments, experience management system 260 can create and provide real-time content to the mobile device. In some embodiments, the personalized content includes at least one of messages from people that are not currently present in the environment, a video, an avatar model, additional information about the respective object and real-time information associated with the respective object. In some embodiments, user experience application 220 can augment a real-world view of in-space scene and graphic with overlays of associated media or personalized content for the respective object through the mobile device. Continuing the example above, the recruit can point mobile device 110 at defined points, so that mobile device 110 can receive and stream associated media in an augmented view.

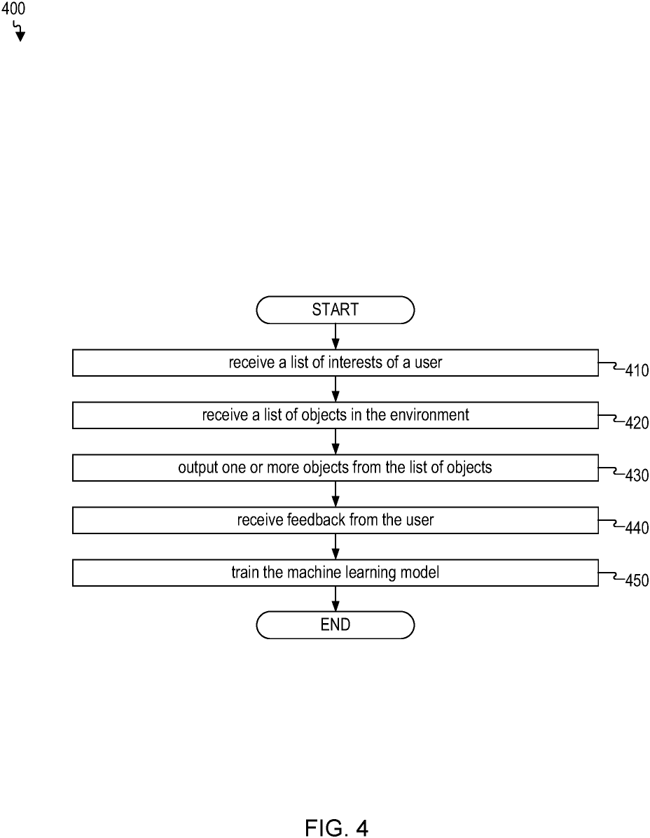

FIG. 4 illustrates an example method 400 for training a machine learning model to tailor a user experience for a user visiting an environment. Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

According to some embodiments, method 400 includes receiving a list of interests of a user at step 410. For example, AI/ML platform 258 illustrated in FIG. 2 may receive a list of interests of a user.

According to some embodiments, method 400 includes receiving a list of objects in the environment at step 420. For example, AI/ML platform 258 illustrated in FIG. 2 may receive a list of objects in the environment.

According to some embodiments, method 400 includes outputting one or more objects from the list of objects at step 430. For example, AI/ML platform 258 illustrated in FIG. 2 may output one or more objects from the list of objects. In some embodiments, the one or more objects are used to generate a personalized or customized tour including each of the one or more objects.

According to some embodiments, method 400 includes receiving feedback from the user at step 440. For example, AI/ML, platform 258 illustrated in FIG. 2 may receive feedback from the user. In some embodiments, the feedback indicates whether the user was interested in each of the one or more objects. In some embodiments, the feedback can include machine computed suggestions based on both specifically defined logic inputs (e.g., answer to “what is your favorite color”) and deep computer user group comparisons performed across analytics data cube. Additionally, feedback can be obtained based on other analyses. For example, AI/ML platform 258 can determine, based on sensor data, how long a user has dwelled on a particular object, whether the user continues onto other waypoints in the personalized tour, etc. These factors can all be used to determine whether particular objects and interests are suited for each user.

According to some embodiments, method 400 includes training the machine learning model based on the list of interests, the list of objects, the one or more objects, and the feedback at step 450. For example, AI/ML platform 258 illustrated in FIG. 2 may train the machine learning model based on the list of interests, the list of objects, the one or more objects, and the feedback. In some embodiments, the machine learning model is encouraged when the user indicates interest in one object of the one or more objects. In some embodiments, the machine learning model is discouraged when the user does not indicate interest in the one object. In some embodiments, the machine learning model is configured to associate or increase a strength of an association of the object with an interest in the list of interests when the user indicates interest in the one object.

It is further considered that remote computing system 250 can communicate real-time engagement analytic, usage states, and machine-learning analyses of captured images that do not have associated triggers in experience management system 260 to experience management system 260, so that experience management system 260 can update interests, objects of interest, etc. The updated information can then be used to improve and further personalize experiences.

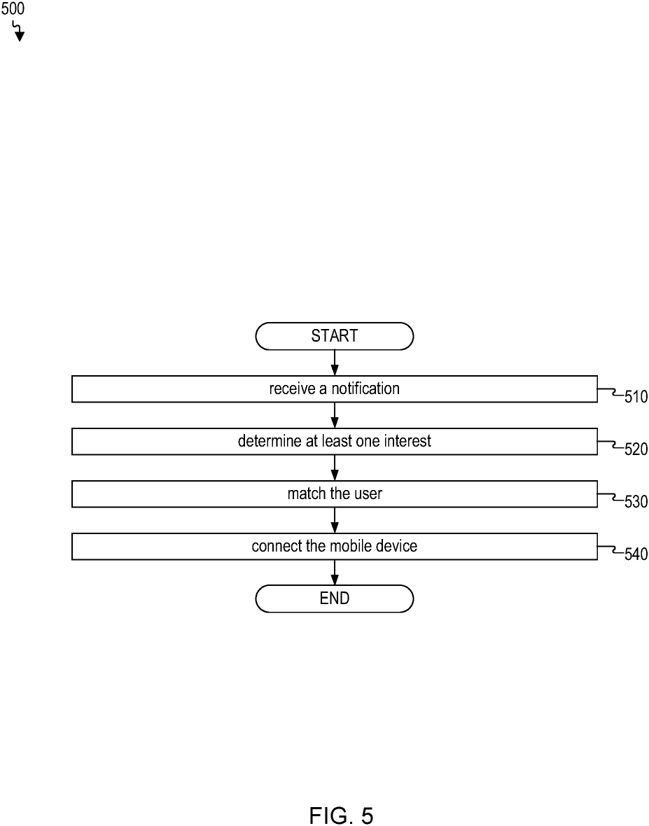

FIG. 5 illustrates an example method 500 for generating content associated with tailored user experiences based on user interests and an environment. Although the example method 500 depicts a particular sequence of operations, the sequence may be altered without departing from the scope of the present disclosure. For example, some of the operations depicted may be performed in parallel or in a different sequence that does not materially affect the function of method 500. In other examples, different components of an example device or system that implements method 500 may perform functions at substantially the same time or in a specific sequence.

According to some embodiments, method 500 includes receiving a notification from a mobile device associated with a user at step 510. For example, content management service 260 illustrated in FIG. 2 may receive a notification from a mobile device associated with a user. In some embodiments, the notification indicates that the user is interested in connecting with other people in the environment.

According to some embodiments, method 500 includes determining at least one interest of the user at step 520. For example, content management service 260 illustrated in FIG. 2 may determine at least one interest of the user.

According to some embodiments, method 500 includes matching the user with a second user based on the at least one interest at step 530. For example, content management service 260 illustrated in FIG. 2 may match the user with a second user based on the at least one interest.

According to some embodiments, method 500 includes connecting the mobile device associated with the user with a mobile device of the second user through a user experience application at step 540. For example, content management service 260 illustrated in FIG. 2 may connect the mobile device associated with the user with a mobile device of the second user through a user experience application.

Furthermore, all of the data in steps 520, 530, and 540 can be stored in and used by an analytics cube for continuous improvement of a machine learning form of experience management system 260.

It is also contemplated that user experience application 220 can generate content based on a branded package. For example, package content can prompt a user to download user experience application 220 and direct the user to point a camera of mobile device 110 to the package contents. User experience application 220 can detect a unique visual signature as a trigger (e.g., similar to the totems or signage in environments as discussed above) and request associated media from experience management system 260. User experience application 220 can then augment real-world view of the package with an overlay of the associated media received from experience management system 260. The associated media can be personalized to the package recipient through various methods including, but not limited to, pre-recorded video/audio, real-time created media elements injected with personalized data, etc.

It is further considered that experience management service 260 can also provide users with tailored commercial content. For example, experience management service 260 can determine that a user has stared at Heisman trophies in a space. Experience management service 260 can then send a notification to the mobile device 110 associated with the user to buy a replica trophy.

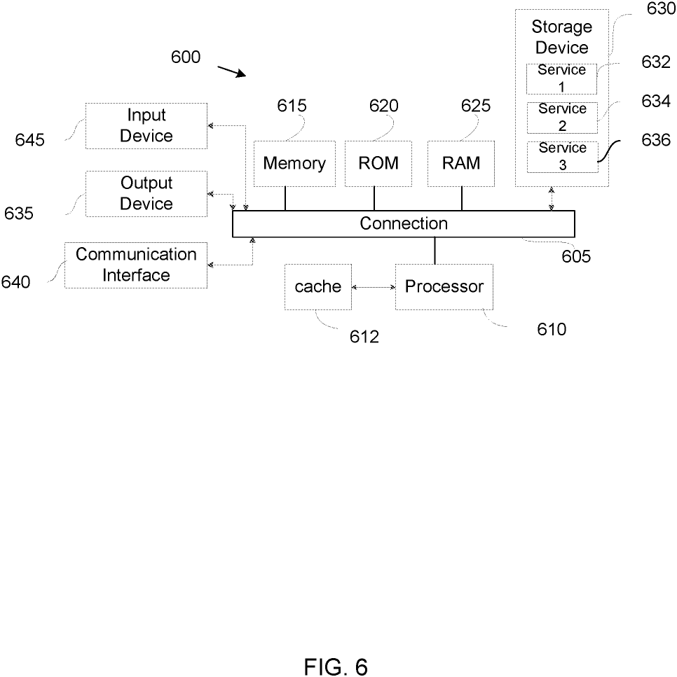

FIG. 6 shows an example of computing system 600, which can be for example any computing device making up mobile device 110, remote computing system 250, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random access memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement, and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed:

1. A computer-implemented method for developing tailored user experiences based on user interests and environmental data stored in an experience management system, the method comprising:
determining that a mobile device associated with a user has entered an environment associated with a personalized experience tour;
receiving spatial information from the mobile device, wherein the spatial information includes contextual information of a portion of the environment that the user is in;
determining, based on an identity of the user, subjects that the user is interested in;
generating, based on the subjects that the user is interested in, one or more waypoints, wherein the one or more waypoints are objects in the environment that the user may be interested in;
guiding the user to the one or more waypoints; and
providing personalized content for a respective object through the mobile device to the user at the one or more waypoints.

2. The computer-implemented method of claim 1, wherein determining that the mobile device has entered the environment includes receiving a notification that the mobile device has scanned a code or trigger in the environment, wherein the code is configured to send the notification to the experience management system.

3. The computer-implemented method of claim 1, wherein the spatial information is obtained as sensor data from sensors of the mobile device.

4. The computer-implemented method of claim 3, wherein the sensor data is positional data from a GPS sensor.

5. The computer-implemented method of claim 3, wherein the sensor data is image data from a camera of the mobile device.

6. The computer-implemented method of claim 1, wherein determining the subjects that the user is interested in includes receiving a list of interests from the mobile device that the user generates.

7. The computer-implemented method of claim 1, wherein determining the subjects that the user is interested in includes analyzing biometric data of the user in response to an object in the portion of the environment.

8. The computer-implemented method of claim 1, wherein determining the subjects that the user is interested in includes using a machine learning to determine potential interests of the user.

9. The computer-implemented method of claim 1, wherein generating the one or more waypoints includes searching a database stored on the experience management system.

10. The computer-implemented method of claim 1, wherein the personalized content includes at least one of messages from people that are not currently present in the environment, a video, an avatar model, additional information about the respective object and real-time information associated with the respective object.

11. A system for developing tailored user experiences based on user interests and environmental data, the system comprising:
one or more processors; and
one or more memories storing computer-executable instructions, wherein the instructions, when executed by the one or more processors, cause the one or more processors to perform operations comprising:
determining that a mobile device associated with a user has entered an environment associated with a personalized experience tour;
receiving spatial information from the mobile device, wherein the spatial information includes contextual information of a portion of the environment that the user is in;
determining, based on an identity of the user, subjects that the user is interested in;
generating, based on the subjects that the user is interested in, one or more waypoints, wherein the one or more waypoints are objects in the environment that the user may be interested in;
guiding the user to the one or more waypoints; and
providing personalized content for a respective object through the mobile device to the user at the one or more waypoints.

12. The system of claim 11, wherein determining that the mobile device has entered the environment includes receiving a notification that the mobile device has scanned a code or trigger in the environment, wherein the code is configured to send the notification to the experience management system.

13. The system of claim 11, wherein the spatial information is obtained as sensor data from sensors of the mobile device.

14. The system of claim 13, wherein the sensor data is positional data from a GPS sensor.

15. The system of claim 13, wherein the sensor data is image data from a camera of the mobile device.

16. The system of claim 11, wherein determining the subjects that the user is interested in includes receiving a list of interests from the mobile device that the user generates.

17. The system of claim 11, wherein determining the subjects that the user is interested in includes analyzing biometric data of the user in response to an object in the portion of the environment.

18. The system of claim 11, wherein determining the subjects that the user is interested in includes using a machine learning to determine potential interests of the user.

19. A computer-implemented method for training a machine learning model to tailor a user experience for a user visiting an environment, the method comprising:
receiving a list of interests of a user;
receiving a list of objects in the environment;
outputting one or more objects from the list of objects, wherein the one or more objects are used to generate a tour including each of the one or more objects;
receiving feedback from the user, wherein the feedback indicates whether the user was interested in each of the one or more objects; and
training the machine learning model based on the list of interests, the list of objects, the one or more objects, and the feedback, wherein the machine learning model is encouraged when the user indicates interest in one object of the one or more objects, and wherein the machine learning model is discouraged when the user does not indicate interest in the one object.

20. The computer-implemented method of claim 19, wherein the machine learning model is configured to associate or increase a strength of an association of the object with an interest in the list of interests when the user indicates interest in the one object.
